(19) United States
(12) Patent Application Publication
(10) Pub. No.: US 2018/0035169 A1
(43) Pub. Date: Feb. 1, 2018

(54) METHOD, APPARATUS, HOST TERMINAL AND SYSTEM FOR PROCESSING LIVE BROADCASTING INFORMATION

(71) Applicant: Beijing Xiaomi Mobile Software Co., Ltd., Beijing (CN)

(72) Inventors: Yanqiang ZHENG, Beijing (CN); Wei LIU, Beijing (CN); Chao SUN, Beijing (CN)

(73) Assignee: Beijing Xiaomi Mobile Software Co., Ltd., Beijing (CN)

(21) Appl. No.: 15/649,299

(22) Filed: Jul. 13, 2017

(30) Foreign Application Priority Data
Jul. 28, 2016 (CN) 201610615595.0

(51) Int. Cl. H04N 21/4788; H04N 21/262; H04N 21/488; H04N 21/2187

(52) U.S. Cl. CPC H04N 21/4788; H04N 21/2187; H04N 21/26216; H04N 21/4882

(57) ABSTRACT

The present disclosure relates to a method, apparatus, and a system including host terminal, interaction server terminal, and live broadcasting server for processing live broadcasting information. The method includes: receiving live broadcasting interaction information sent by an interaction server, combining the live broadcasting interaction information and a live broadcasting video stream to get a target video stream, and sending the target video stream to a live broadcasting server to enable the live broadcasting server to send the target video stream to other audience terminals.

### CROSS-REFERENCE TO RELATED APPLICATION

This application is based on and claims priority to Chinese Patent Application No. 201610615595.0 filed on Jul. 28, 2016, the entire contents of which are incorporated herein by reference in its entirety.

### FIELD

The present disclosure relates to the technical field of live broadcasting, and more particularly to a method, an apparatus and a system including host terminal, interaction sever terminal, live broadcasting sever for processing live broadcasting information.

### BACKGROUND

After a live broadcasting room is created by a host, an audience may communicate with the host or other audiences by sending live broadcasting interaction information, such as screen information, in the live broadcasting room. However, after a piece of live broadcasting interaction information is sent by any audience terminal, the live broadcasting interaction information may be broadcasted to the host terminal and all the other audience terminals. This manner of sending interaction information increases the consumption of bandwidth significantly, and also increases the cost and power consumption of a device. Especially, when the number of audiences in the live broadcasting room increases sharply, the number of times for sending the live broadcasting interaction information increases significantly, resulting in great device cost and bandwidth cost.

### SUMMARY

Embodiments of the present disclosure provides a method, an apparatus and a system including a host terminal, an interaction sever terminal, a live broadcasting sever for processing live broadcasting information.

In accordance with a first aspect of embodiments of the present disclosure, a method for processing live broadcasting information is provided. The method may include: receiving live broadcasting interaction information sent by an interaction server, the live broadcasting interaction information being sent to the interaction server by an interacting audience terminal; combining the live broadcasting interaction information and a live broadcasting video stream to get a target video stream; and sending the target video stream to a live broadcasting server to enable the live broadcasting server to send the target video stream to other audience terminals, wherein the interacting audience terminal is any one of audience terminals in the live broadcasting room where the host terminal resides, and the other audience terminals are audience terminals in the live broadcasting room except the interacting audience terminal.

In accordance with a second aspect of embodiments of the present disclosure, an apparatus used at a host terminal is provided, the apparatus may include: a processor; a memory for storing processor-executable instructions that may be executable by the processor; wherein the processor may be configured to: receive live broadcasting interaction information sent by an interaction server, the live broadcasting interaction information being sent to the interaction server by an interacting audience terminal; combine the live broadcasting interaction information and a live broadcasting video stream to get a target video stream; and send the target video stream to a live broadcasting server to enable the live broadcast server to send the target video stream to other audience terminals, wherein the interacting audience terminal is any one of audience terminals in the live broadcasting room where the host terminal resides, and the other audience terminals are audience terminals in the live broadcasting room except the interacting audience terminal.

In accordance with a third aspect of embodiments of the present disclosure, a system for processing live broadcasting information is provided. The system may include a host terminal, an interaction server and a live broadcasting server; where the host terminal may include a host apparatus for processing live broadcasting information; the interaction server may include an interaction apparatus for processing the live broadcasting information, the interaction apparatus including a first processor; a first memory for storing first processor-executable instructions that may be executable by the first processor, where the first processor may be configured to: receive live broadcasting interaction information sent by an interacting audience terminal; and send the live broadcasting interaction information to the host terminal, where the interacting audience terminal may be any one of audience terminals in the live broadcasting room where the host terminal resides.

The live broadcasting server included in the system may include a broadcasting apparatus for processing the live broadcasting information, the broadcasting apparatus including a second processor; a second memory for second storing processor-executable instructions that may be executable by the second processor, where the second processor may be configured to: receive a target video stream sent by the host terminal, the target video stream being a combination of the live broadcasting interaction information and a live broadcasting video stream; and send the target video stream to other audience terminal, the other audience terminal being any one of audience terminals in the live broadcasting room where the host terminal resides except an interacting audience terminal, the interacting audience terminal being the audience terminal sending the live broadcasting interaction information.

It is to be understood that the forgoing general description and the following detailed description are illustrative and explanatory only, and are not intended to limit the present disclosure.

### BRIEF DESCRIPTION OF THE DRAWINGS

The accompanying drawings, which are incorporated in and constitute a part of this specification, illustrate embodiments consistent with the present disclosure and, together with the specification, serve to explain the principles of the present disclosure.

FIG. 1 is a flow chart illustrating a method for processing live broadcasting information according to an exemplary embodiment;

FIG. 2 is a flow chart illustrating another method for processing live broadcasting information according to an exemplary embodiment;

FIG. 3 is a flow chart illustrating yet another method for processing live broadcasting information according to an exemplary embodiment;

FIG. 4 is a block diagram illustrating an apparatus for processing live broadcasting information according to an exemplary embodiment;

FIG. 5 is a block diagram illustrating another apparatus for processing live broadcasting information according to an exemplary embodiment;

FIG. 6A is a block diagram illustrating yet another apparatus for processing live broadcasting information according to an exemplary embodiment;

FIG. 6B is a block diagram illustrating a system for processing live broadcasting information according to an exemplary embodiment.

FIG. 7 is a block diagram illustrating an apparatus suitable for processing live broadcasting information according to an exemplary embodiment.

FIG. 8 is a block diagram illustrating another apparatus suitable for processing live broadcasting information according to an exemplary embodiment.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various examples of the present disclosure. Also, common but well-understood elements that are useful or necessary in a commercially feasible example are often not depicted in order to facilitate a less obstructed view of these various examples. It will further be appreciated that certain actions and/or steps may be described or depicted in a particular order of occurrence while those skilled in the art will understand that such specificity with respect to sequence is not actually required. It will also be understood that the terms and expressions used herein have the ordinary technical meaning as is accorded to such terms and expressions by persons skilled in the technical field as set forth above, except where different specific meanings have otherwise been set forth herein.

### DETAILED DESCRIPTION

Exemplary embodiments will now be illustrated in detail, examples of which are illustrated in the accompanying drawings. When the following description refers to the accompanying drawings, the same numbers in different drawings represent the same or similar elements, unless otherwise described. The implementations described in the following exemplary embodiments do not represent all of the implementations consistent with the present disclosure. Instead, they are only examples of devices and methods consistent with aspects of the present disclosure as recited in the appended claims.

The terminology used in the present disclosure is for the purpose of describing exemplary examples only and is not intended to limit the present disclosure. As used in the present disclosure and the appended claims, the singular forms “a,” “an” and “the” are intended to include the plural forms as well, unless the context clearly indicates otherwise. It shall also be understood that the terms “or” and “and/or” used herein are intended to signify and include any or all possible combinations of one or more of the associated listed items, unless the context clearly indicates otherwise.

It shall be understood that, although the terms “first,” “second,” “third,” etc. may be used herein to describe various information, the information should not be limited by these terms. These terms are only used to distinguish one category of information from another. For example, without departing from the scope of the present disclosure, first information may be termed as second information; and similarly, second information may also be termed as first information. As used herein, the term “if” may be understood to mean “when” or “upon” or “in response to” depending on the context.

Reference throughout this specification to “one embodiment,” “an embodiment,” “exemplary embodiment,” or the like in the singular or plural means that one or more particular features, structures, or characteristics described in connection with an example is included in at least one embodiment of the present disclosure. Thus, the appearances of the phrases “in one embodiment” or “in an embodiment,” “in an exemplary embodiment,” or the like in the singular or plural in various places throughout this specification are not necessarily all referring to the same embodiment. Furthermore, the particular features, structures, or characteristics in one or more embodiments may be combined in any suitable manner.

After a live broadcasting room is created by a host, audiences may communicate with the host or other audiences by sending live broadcasting interaction information, such as screen information, in the live broadcasting room. However, after a piece of live broadcasting interaction information is sent by any audience terminal, the live broadcasting interaction information may be broadcasted to the host terminal and all the other audience terminals. This method for sending interaction information increases the consumption of bandwidth significantly, and the cost and power consumption of devices. Especially, when the number of audiences in the live broadcasting room increases sharply, the times for sending the live broadcasting interaction information increases significantly, resulting in great device cost and bandwidth cost.

In addition, webcast audio/video data stream and text data stream (i.e., the live broadcasting interaction information) occupy one communication channel independently, which requires additional channel distribution when the live broadcasting server sends the live broadcasting interaction information to audience terminals, which may consume additional resources and may add costs to run and maintain the system.

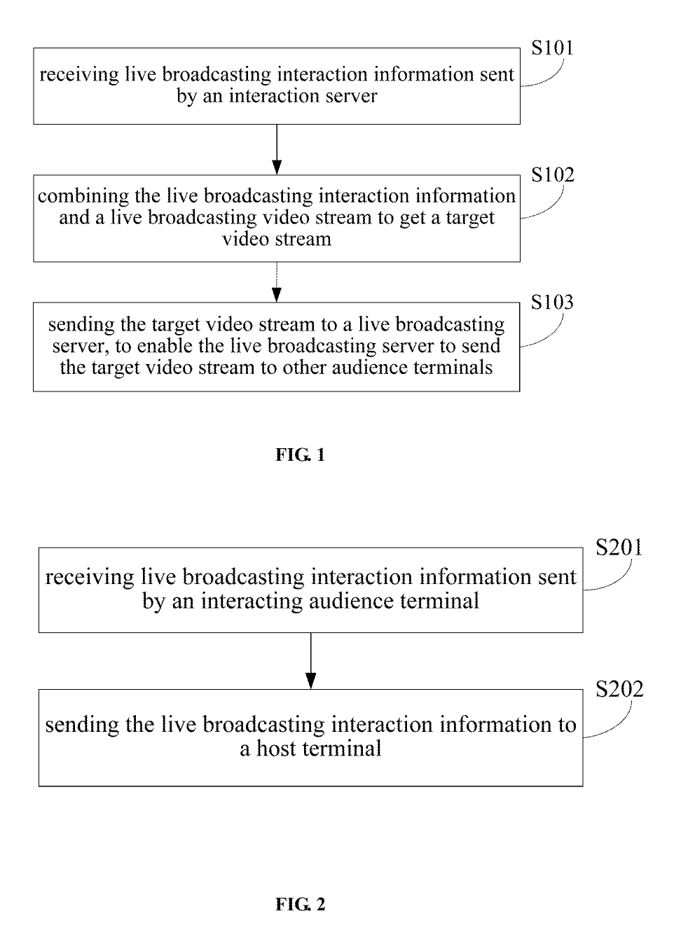

To solve the foregoing technical problems, embodiments of the present disclosure provide a method for processing live broadcasting information. This method may be used in program, system and apparatus for processing live broadcasting information and the execution subject corresponding to the method may be terminals such as mobile phone, tablet, computer, etc. As shown in FIG. 1, the method may include steps S101 to S103.

In step S101, live broadcasting interaction information sent by an interaction server may be received, the live broadcasting interaction information may be sent to the interaction server by an interacting audience terminal.

The live broadcasting interaction information may be one or more pieces of screen information and/or one or more pieces of gift animation information sent by an interacting audience terminal, while the interacting audience terminal may be any one or more of audience terminals in the live broadcasting room where the host terminal resides.

In step S102, the live broadcasting interaction information and a live broadcasting video stream may be combined to get a target video stream.

The live broadcasting video stream may be the video stream need to be played by the host terminal when the webcast is ongoing, and the live broadcasting video stream may include live broadcasting video information and/or live broadcasting audio information.

By combining the live broadcasting interaction information and the live broadcasting video stream, a target video stream carrying the live broadcasting interaction information may be acquired, such that an audience terminal can see the screen information and/or the host terminal's gift sent by an interacting audience terminal which sends the live broadcasting interaction information directly while watching the live broadcasting of the host terminal.

In addition, when combining the live broadcasting interaction information and the live broadcasting video stream, if the live broadcasting video stream has multiple frames of video stream, then the live broadcasting interaction information may be combined with any one of the multiple frames of video stream. After the combination, the live broadcasting interaction information and the live broadcasting video stream may respectively occupy one image layer, to make it convenient for audiences to hide or filter out the live broadcasting interaction information if they do not want to watch the live broadcasting interaction information.

In step S103, the target video stream may be sent to a live broadcasting server to enable the live broadcasting server to send the target video stream to other audience terminals, where the interacting audience terminal may be any one or more of audience terminals in the live broadcasting room where the host terminal resides, the other audience terminals may be audience terminals in the live broadcasting room except the one or more interacting audience terminals.

By sending the target video stream combined from the live broadcasting interaction information and live broadcasting video stream to the live broadcasting server, it is convenient for the live broadcasting server to send the target video stream to the other audience terminals, such that an audience terminal can see the screen information and/or the host terminal's gift sent by an interacting audience terminal which sends the live broadcasting interaction information directly while watching the live broadcasting of the host terminal.

In this way to combine the live broadcasting interaction information and live broadcasting video stream, the interaction server may only need to send the live broadcasting interaction information for one time (i.e., to the host terminal) to make all the other audience terminals in the live broadcasting room can see the live broadcasting interaction information sent by the interacting audience terminal, regardless of how many audiences are in the live broadcasting room. This avoids the need to send the live broadcasting interaction information to all the other audiences in the live broadcasting room to make the other audience terminals in the live broadcasting room can see the live broadcasting interaction information when the interaction server receives the live broadcasting interaction information, resulting in reduction of times for sending the live broadcasting interaction information and reduction of bandwidth occupation.

In addition, by combining the live broadcasting interaction information and the live broadcasting video stream, the live broadcasting video stream and the live broadcasting interaction information may share one channel, which avoids consuming the extra network cost resulting from additional channel occupation and usage.

In one embodiment, the live broadcasting video stream may include live broadcasting video information and/or live broadcasting audio information.

The live broadcasting interaction information may include screen information or gift animation information, where the screen information may include at least one of: text information, system prompting information, and emoticon information.

The live broadcasting interaction information may be screen information or gift animation information used to represent the gift given to the host terminal by an interacting audience terminal, while the screen information may include but not limited to: text information, emoticon information, and system prompting information sent by the interacting audience terminal, for example, image information sent by the interacting audience terminal may also be included.

In addition, the system prompting information may include: prompting information for an interacting audience terminal sends a gift, prompting information for an interacting audience terminal enters the live broadcasting room, prompting information for an interacting audience terminal leaves the live broadcasting room, prompting information activated by an interacting audience terminal, etc.

Embodiments of the present disclosure provide another method for processing live broadcasting information. The execution subject corresponding to this method may be an interaction server access layer between the host terminal and audience terminals (application (APP) between the host terminal and audience terminals), wherein the interaction server may store identification information (e.g., address information) of the host terminal and audience terminals. The method may include:

As shown in FIG. 2, in step S201, live broadcasting interaction information sent by an interacting audience terminal may be received.

In step S202, the live broadcasting interaction information may be sent to a host terminal, where the interacting audience terminal may be any one of audience terminals in the live broadcasting room where the host terminal resides.

When the live broadcasting interaction information sent by any one of the audience terminals in the live broadcasting room is received, by sending the live broadcasting interaction information to the host terminal directly, rather than to the host terminal as well as all the other audience terminals, the interaction server may only need to send the live broadcasting interaction information for one time, regardless of how many audience terminals are in the live broadcasting room.

In this way, the need may be avoided for the interaction server to send the live broadcasting interaction information to all the other audiences in the live broadcasting room to make the other audience terminals in the live broadcasting room are able to watch the live broadcasting interaction information. Thus, on the basis of reduced times for sending the live broadcasting interaction information and reduced bandwidth occupation, the host terminal may combine the live broadcasting interaction information and its live broadcasting video stream and then send the target video stream to other audience terminals by the live broadcasting server, to ensure that other audience terminals may watch the live broadcasting interaction information sent by the interacting audience terminal while watching the live broadcasting video stream of the host terminal.

The present embodiment may reduce the times for sending the live broadcasting interaction information and occupied bandwidth, thus the power consumption of the interaction server may be reduced, and the configuration requirement for the interaction server and device cost may be lower.

Sometimes, it may be possible to provide a choice for the sender of the live broadcasting interaction information such as an audience terminal in the live broadcasting room to send the live broadcasting interaction information. For example, the audience terminal may send the live broadcasting interaction information to a server and the server may combine the live broadcasting interaction information and the live broadcasting video stream and send to other audience terminals. On the other hand, the audience terminal may have an option to also send the live broadcasting interaction information directly to other audience terminals.

When the audience terminal chooses to send the live broadcasting interaction information directly to other audience terminals. The audience terminal may further to have an option to send the live broadcasting interaction information to one or more audience terminals, and the one or more audience terminals may be a subset of audience terminals that the live broadcasting interaction information may be sent to. For example, the audience terminal may send the live broadcasting interaction information directly to one other audience terminal it chooses. Alternatively, the audience terminal may send the live broadcasting interaction information directly to more than one audience terminals.

Sometimes, the audience terminal may designate one or more receiving audience terminals for the live broadcasting interaction information. For example, when a server receives the live broadcasting interaction information from an audience terminal, the server may also receive a request from the audience terminal to designate one or more receiving audience terminals for the live broadcasting interaction information. The server may combine the live broadcasting interaction information and the live broadcasting video stream to form a target video stream and send the target video stream to the one or more receiving audience terminals requested by the audience terminal.

Sometimes the server may determine only send the combined target video stream to a subset of the possible receiving audience terminals. For example, when the server receives the live broadcasting interaction information from an audience terminal and forms the target video stream by combining the live broadcasting interaction information and the live broadcasting video stream, the server may determine the receiving audience terminals according to the content of the live broadcasting interaction information or according to other predetermined categories, and send the target video stream to the determined receiving audience terminals. The determined receiving audience terminals may be a subset of the receiving audience terminals that the server may send the target video stream to.

As described above, the live broadcasting interaction information may be screen information or gift animation information. In addition, the live broadcasting interaction information may be other type of information that an audience terminal may send to one or more receiving terminals. Particularly, the live broadcasting interaction information may be information that an audience terminal may send to more than one receiving terminals.

In one embodiment, the live broadcasting interaction information may include screen information or gift animation information, where the screen information may include at least one of: text information, system prompting information, and emoticon information.

The live broadcasting interaction information may be screen information or gift animation information used to represent the gift given to the host terminal by an interacting audience terminal, while the screen information may include but not limited to: text information, emoticon information, and system prompting information sent by the interacting audience terminal, for example, image information sent by the interacting audience terminal may also be included. The system prompting information may include: prompting information for an interacting audience terminal sends a gift, prompting information for an interacting audience terminal enters the live broadcasting room, prompting information for an interacting audience terminal leaves the live broadcasting room, prompting information activated by an interacting audience terminal, etc.

Embodiments of the present disclosure provide yet another method for processing live broadcasting information. This method may be used at a live broadcasting server, and the network used by the live broadcasting server may be Content Delivery Network. The method may include:

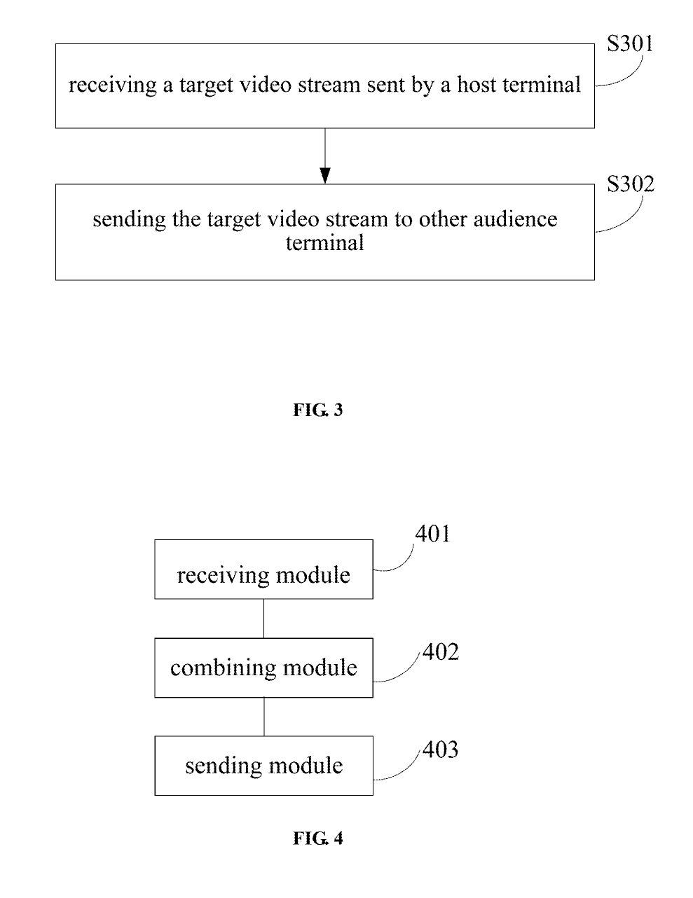

As shown in FIG. 3, in step S301, a target video stream sent by a host terminal may be received, the target video stream may be a combination of live broadcasting interaction information and a live broadcasting video stream.

In step S302, the target video stream may be sent to other audience terminal, the other audience terminal may be any one of audience terminals in the live broadcasting room where the host terminal resides except an interacting audience terminal, and the interacting audience terminal may be the audience terminal sending the live broadcasting interaction information.

By sending the target video stream combined from the live broadcasting interaction information and live broadcasting video stream to other audience terminals, an audience terminal can see the screen information and/or the host terminal's gift sent by an interacting audience terminal which sends the live broadcasting interaction information directly while watching the live broadcasting of the host terminal.

In this way to combine the live broadcasting interaction information and live broadcasting video stream, the interaction server may only need to send the live broadcasting interaction information for one time to make all the other audience terminals in the live broadcasting room can see the live broadcasting interaction information sent by the interacting audience terminal. This avoids the need for the interaction server to send the live broadcasting interaction information to all the other audiences in the live broadcasting room to make the other audience terminals in the live broadcasting room can see the live broadcasting interaction information when the live broadcasting interaction information is received, so as to reduce the times for sending the live broadcasting interaction information and bandwidth occupation.

In addition, a server may push the target video stream to other audience terminals actively when sending the target video stream to other audience terminals, or when a request sent by other audience terminals for acquiring the live broadcasting video stream is received. The audience terminals may acquire the target video stream carrying the live broadcasting interaction information sent by the host terminal according to the address of the video stream of the host terminal in the live broadcasting server carried in the request. The server may thus send the target video stream carrying the live broadcasting interaction information to other audience terminals.

Corresponding to the foregoing method for processing live broadcasting information provided by embodiments of the present disclosure, the fourth aspect of the embodiments of the present disclosure also provides an apparatus for processing the live broadcasting information, which may be used at the host terminal. As shown in FIG. 4, the apparatus may include:

A receiving module 401 may be configured to receive live broadcasting interaction information sent by an interaction server, the live broadcasting interaction information may be sent to the interaction server by an interacting audience terminal.

A combining module 402 may be configured to combine the live broadcasting interaction information and a live broadcast video stream to get a target video stream.

A sending module 403 may be configured to send the target video stream to a live broadcasting server, to enable the live broadcast server to send the target video stream to other audience terminals, where the interacting audience terminal may be any one of audience terminals in the live broadcasting room where the host terminal resides, the other audience terminals may be audience terminals in the live broadcasting room except the interacting audience terminal.

In one embodiment, the live broadcasting video stream may include live broadcasting video information and/or live broadcasting audio information.

The live broadcasting interaction information may include screen information or gift animation information, where the screen information may include at least one of: text information, system prompting information, and emoticon information.

Corresponding to the foregoing method for processing live broadcasting information provided by embodiments of the present disclosure, the fifth aspect of the embodiments of the present disclosure also provides another apparatus for processing the live broadcasting information, which may be used at the interaction server. As shown in FIG. 5, the apparatus may include:

A receiving module 501 may be configured to receive live broadcasting interaction information sent by an interacting audience terminal.

A sending module 502 may be configured to send the live broadcasting interaction information to a host terminal, where the interacting audience terminal may be any one of audience terminals in the live broadcasting room where the host terminal resides.

In one embodiment, the live broadcasting interaction information may include screen information or gift animation information, wherein the screen information may include at least one of: text information, system prompting information, and emoticon information.

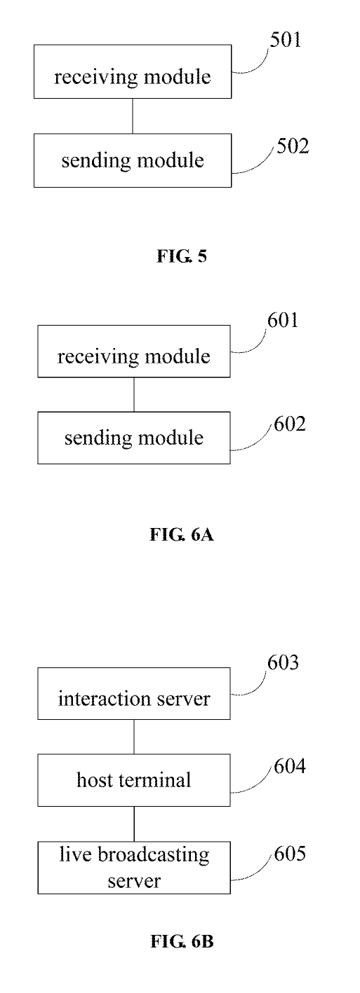

Corresponding to the foregoing method for processing live broadcasting information provided by embodiments of the present disclosure, the sixth aspect of the embodiments of the present disclosure also provides yet another apparatus for processing the live broadcasting information, which may be used at the live broadcasting server. As shown in FIG. 6A, the apparatus may include:

A receiving module 601 may be configured to receive a target video stream sent by a host terminal, and the target video stream may be a combination of live broadcasting interaction information and a live broadcasting video stream.

A sending module 602 may be configured to send the target video stream to other audience terminal, the other audience terminal may be any one of audience terminals in the live broadcasting room where the host terminal resides except an interacting audience terminal, the interacting audience terminal may be the audience terminal sending the live broadcasting interaction information.

As shown in FIG. 6B, corresponding to the foregoing method for processing live broadcasting information provided by embodiments of the present disclosure, the seventh aspect of the embodiments of the present disclosure also provides a system for processing the live broadcasting information, the system may include: a host terminal 604, an interaction server 603 and a live broadcasting server 605.

The host terminal 604 may include the apparatus for processing live broadcasting information described in any of the foregoing fourth aspect of embodiments.

The interaction server 603 may include the apparatus for processing live broadcasting information described in any of the foregoing fifth aspect of embodiments.

The live broadcasting server 605 may include the apparatus for processing live broadcasting information described in the foregoing sixth aspect of embodiments.

In addition, the system should also include other audience terminals in the live broadcasting room where the host terminal 604 resides except the interacting audience terminal. The technical effect of the system is the same as that of the foregoing method for processing live broadcasting information, which is omitted here.

In accordance with the eighth aspect of embodiments of the present disclosure, a host terminal is provided. The host terminal may include: a processor; a memory for storing processor-executable instructions; where the processor may be configured to: receive live broadcasting interaction information sent by an interaction server, and the live broadcasting interaction information may be sent to the interaction server by an interacting audience terminal; combine the live broadcasting interaction information and a live broadcasting video stream to get a target video stream; and send the target video stream to a live broadcasting server to enable the live broadcast server to send the target video stream to other audience terminals, where the interacting audience terminal may be any one of audience terminals in the live broadcasting room where the host terminal resides, and the other audience terminals may be audience terminals in the live broadcasting room except the interacting audience terminal.

The processor may also be configured to: the live broadcasting video stream may include live broadcasting video information and/or live broadcasting audio information; the live broadcasting interaction information may include screen information or gift animation information, where the screen information may include at least one of: text information, system prompting information, and emoticon information.

In accordance with the ninth aspect of embodiments of the present disclosure, an interaction server is provided. The interaction server may include: a processor; a memory for storing processor-executable instructions; where the processor may be configured to: receive live broadcasting interaction information sent by an interacting audience terminal; and send the live broadcasting interaction information to a host terminal, where the interacting audience terminal may be any one of audience terminals in the live broadcasting room where the host terminal resides.

The live broadcasting interaction information may include screen information or gift animation information, where the screen information may include at least one of: text information, system prompting information, and emoticon information.

In accordance with the tenth aspect of embodiments of the present disclosure, a live broadcasting server is provided. The live broadcasting server may include: a processor; a memory for storing processor-executable instructions; where the processor may be configured to: receive a target video stream sent by a host terminal, the target video stream may be a combination of live broadcasting interaction information and a live broadcasting video stream; and send the target video stream to other audience terminal, the other audience terminal may be any one of audience terminals in the live broadcasting room where the host terminal resides except an interacting audience terminal, the interacting audience terminal may be the audience terminal sending the live broadcasting interaction information.

As shown in FIG. 6B, corresponding to the foregoing method for processing live broadcasting information provided by embodiments of the present disclosure, the eleventh aspect of the embodiments of the present disclosure also provides another system for processing the live broadcasting information, the system may include:

The host terminal 604 described in the foregoing eighth aspect of embodiments.

The interaction server 603 described the foregoing ninth aspect of embodiments.

The live broadcasting server 605 described in the foregoing tenth aspect of embodiments.

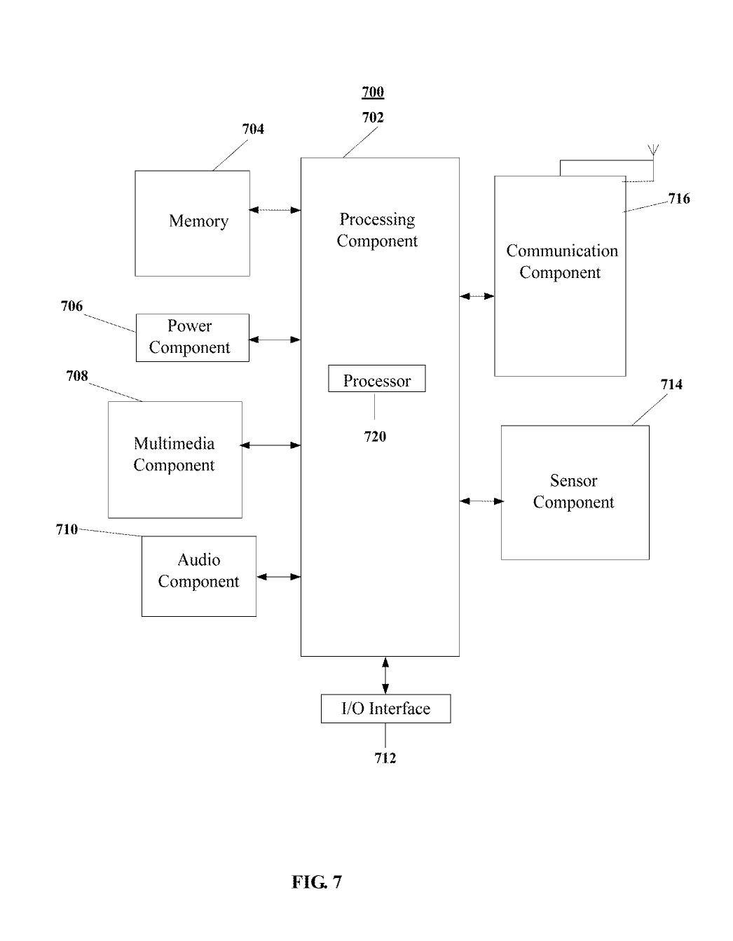

FIG. 7 is a block diagram of a device 700 for processing the live broadcasting information illustrated according to an exemplary embodiment. For example, the device 700 may be a mobile phone, computer, digital broadcast terminal, messaging device, game console, tablet device, medical device, fitness equipment, personal digital assistant, etc.

Referring to FIG. 7, the device 700 may include one or more of the following components: a processing component 702, a memory 704, a power component 706, a multimedia component 708, an audio component 710, an input/output (I/O) interface 712, a sensor component 714, and a communication component 716.

The processing component 702 typically controls overall operation of the device 700, such as the operations associated with display, telephone call, data communications, camera operations and recording operations. The processing element 702 may include one or more processors 720 to execute instructions to perform all or part of the steps in the above described methods. Additionally, the processing component 702 may include one or more modules which facilitate the interaction between the processing component 702 and other components. For instance, the processing component 702 may include multimedia module to facilitate the interaction between the multimedia component 708 and the processing component 702.

The memory 704 is configured to store various types of data to support the operation of the device 700. Examples of such data include instructions for any applications or methods operated on the device 700, contacts data, phonebook data, messages, images, videos, etc. The memory 704 may be implemented using any type of volatile or non-volatile memory devices or a combination thereof, such as a static random access memory (SRAM), an electrically erasable programmable read only memory (EEPROM), an erasable programmable read only memory (EPROM), a programmable read-only memory (PROM), a read-only memory (ROM), a magnetic memory, a flash memory, a magnetic disk or optical disk.

The power component 706 provides power to various components of the device 700. The power component 706 may include a power management system, one or more power sources, and any other components associated with the generation, management, and distribution of power in the device 700

The multimedia component 708 includes a screen providing an output interface between the device 700 and the user. In some embodiments, the screen may include a liquid crystal display (LCD) and a touch panel (TP). If the screen includes the touch panel, the screen may be implemented as a touch screen to receive input signal from the users. The touch panel includes one or more touch sensors to sense touches, swipes and gestures on the touch panel. The touch sensor may not only sense a boundary of a touch or swipe action, but also detect the duration and pressure associated with the touch or swipe operation. In some embodiments, the multimedia component 708 includes one front camera and/or rear camera. When the device 700 is in an operation mode, such as a shooting mode or a video mode, the front camera and/or rear camera may receive external multimedia data. Each front camera and rear camera may be a fixed optical lens system or have focal length and optical zoom capability.

The audio component 710 is configured to output and/or input audio signals. For example, the audio component 710 includes a microphone (MIC) configured to receive an external audio signal when the device 700 is in an operation mode, such as a call mode, a recording mode and a voice recognition mode. The received audio signal may be further stored in the memory 704 or transmitted via the communication component 716. In some embodiments, the audio component 710 further includes a speaker to output audio signals.

The I/O interface 712 provides an interface between the processing component 702 and peripheral interface modules, such as a keyboard, a click wheel, buttons, and the like. The buttons may include, but are not limited to: a home button, a volume button, a starting button, and a locking button.

The sensor component 714 includes one or more sensors to provide various aspects of state assessments for the device 700. For instance, the sensor component 714 may detect an open/closed state of the device 700, relative positioning of components, such as the display and the keypad of the device 700, the sensor component 714 may also detect a position change of the device 700 or a component thereof, a presence or absence of a contact between the user and the device 700, an orientation or acceleration/deceleration of the device 700, and a temperature change of the device 700. The sensor component 714 may include a proximity sensor configured to detect the presence of nearby objects without any physical contact. The sensor component 714 may further include a light sensor, such as a CMOS or CCD image sensor, for use in imaging applications. In some embodiments, the sensor component 714 may further include an accelerometer sensor, a gyroscope sensor, a magnetic sensor, a pressure sensor, a microwave sensor, or a temperature sensor.

The communication component 716 is configured to facilitate the device 700 to communication, wired or wirelessly, with other devices. The device 700 can access a communication standard based wireless network, such as WiFi, 2G or 3G or a combination thereof. In one exemplary embodiment, the communication component 716 receives a broadcast signal from an external broadcast management system or broadcasts the associated information via a broadcast channel. In one exemplary embodiment, the communication component 716 further includes a near field communication (NFC) module to facilitate short-range communication. For example, the NFC module may be implemented based on radio frequency identification (RFID) technique, infrared data association (IrDA) technique, ultra-wideband (UWB) technique, Bluetooth (BT) technique, and other techniques.

In an exemplary embodiment, the device 700 may be implemented with one or more application specific integrated circuits (ASIC), digital signal processors (DSP), digital signal processing devices (DSPD), programmable logic devices (PLD), field programmable gate arrays (FPGA), controllers, micro-controllers, microprocessors, or other electronic components, for performing the above described methods.

In an exemplary embodiment, there is also provided a non-transitory computer-readable storage medium including instructions, such as the memory 704 including instructions, the instructions can be executed by the processor 720 of the device 700 to implement the above described methods. For example, the non-transitory computer-readable storage medium may be a ROM, a random access memory (RAM), a CD-ROM, a magnetic tape, a floppy disc, and an optical data storage device, etc.

A non-transitory computer-readable storage medium, when the instruction in the storage medium is executed by the processor of the device 700, enable the device 700 to perform a method for processing live broadcasting information which may include: receiving live broadcasting interaction information sent by an interaction server, the live broadcasting interaction information may be sent to the interaction server by an interacting audience terminal; combining the live broadcasting interaction information and a live broadcasting video stream to get a target video stream; and sending the target video stream to a live broadcasting server, to enable the live broadcasting server to send the target video stream to other audience terminals, wherein the interacting audience terminal may be any one of audience terminals in the live broadcasting room where the host terminal resides, the other audience terminals may be audience terminals in the live broadcasting room except the interacting audience terminal.

In one embodiment, the live broadcasting video stream may include live broadcasting video information and/or live broadcasting audio information.

The live broadcasting interaction information may include screen information or gift animation information, wherein the screen information may include at least one of: text information, system prompting information, and emoticon information.

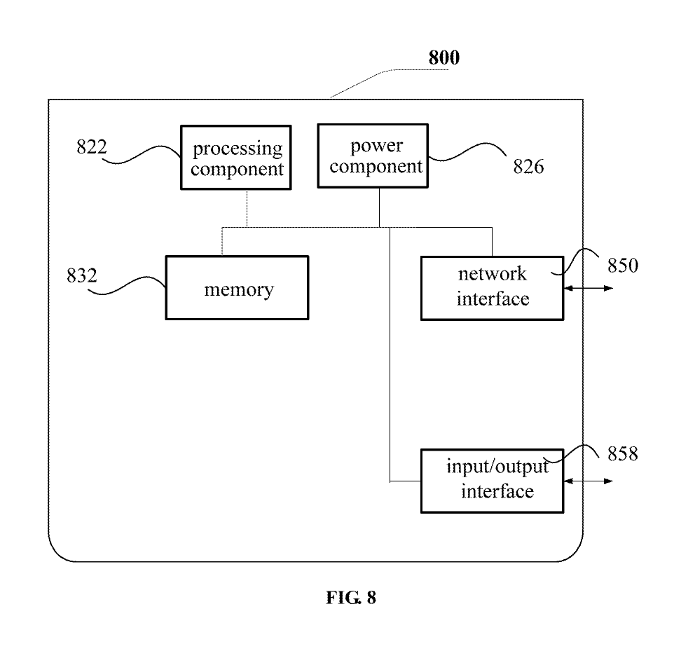

FIG. 8 is a block diagram illustrating an apparatus 800 for processing live broadcasting information according to an exemplary embodiment. For example, the device 800 may be provided as a server. With reference to FIG. 8, the device 800 includes a processing component 822 which may further include one or more processors, and a memory resource represented by the memory 832 which may be configured to store instructions executed by the processing component 822, such as application programs. The application programs stored in the memory 832 may include one or more modules, each of which corresponding to a group of instructions. Moreover, the processing component 822 may be configured to perform instructions to perform the forgoing methods.

The device 800 may also include a power component 826 configured to perform power management of the device 800, a wired or wireless network interface 850 configured to connect the device 800 to the network, and an input/output (I/O) interface 858. The device 800 may operate based on the operating system stored in the memory 832, for example, Windows Server™, Mac OS X™, Unix™, Linux™, FreeBSD™, or similar.

A non-transitory computer-readable storage medium, when the instruction in the storage medium is executed by the processor of the device 800, enable the device 800 to perform a method for processing live broadcasting information which may include: receiving live broadcasting interaction information sent by an interacting audience terminal; and sending the live broadcasting interaction information to a host terminal, wherein the interacting audience terminal may be any one of audience terminals in the live broadcasting room where the host terminal resides.

In one embodiment, the live broadcasting interaction information may include screen information or gift animation information, wherein the screen information may include at least one of: text information, system prompting information, and emoticon information.

A non-transitory computer-readable storage medium, when the instruction in the storage medium is executed by the processor of the device 800, enable the device 800 to perform a method for processing live broadcasting information which may include: receiving a target video stream sent by a host terminal, the target video stream may be a combination of live broadcasting interaction information and a live broadcasting video stream; and sending the target video stream to other audience terminal, the other audience terminal may be any one of audience terminals in the live broadcasting room where the host terminal resides except an interacting audience terminal, the interacting audience terminal may be the audience terminal sending the live broadcasting interaction information.

In accordance with an aspect of embodiments of the present disclosure, a method for processing live broadcasting information is provided. The method may include: receiving live broadcasting interaction information sent by an interacting audience terminal; and sending the live broadcasting interaction information to a host terminal, where the interacting audience terminal may be any one of audience terminals in the live broadcasting room where the host terminal resides.

In accordance with an aspect of embodiments of the present disclosure, another method for processing live broadcasting information is provided. The method may include receiving a target video stream sent by a host terminal, the target video stream being a combination of live broadcasting interaction information and a live broadcasting video stream; and sending the target video stream to other audience terminal, the other audience terminal being any one of audience terminals in the live broadcasting room where the host terminal resides except an interacting audience terminal, the interacting audience terminal being the audience terminal sending the live broadcasting interaction information.

In accordance with an aspect of embodiments of the present disclosure, an apparatus for processing live broadcasting information is provided. The apparatus may include a receiving module configured to receive live broadcasting interaction information sent by an interaction server, the live broadcasting interaction information being sent to the interaction server by an interacting audience terminal; a combining module configured to combine the live broadcasting interaction information and a live broadcast video stream to get a target video stream; and a sending module configured to send the target video stream to a live broadcasting server to enable the live broadcast server to send the target video stream to other audience terminals, where the interacting audience terminal may be any one of audience terminals in the live broadcasting room where the host terminal resides, and the other audience terminals may be audience terminals in the live broadcasting room except the interacting audience terminal.

In accordance with an aspect of embodiments of the present disclosure, an apparatus for processing live broadcasting information is provided. The apparatus may include: a receiving module configured to receive live broadcasting interaction information sent by an interacting audience terminal; and a sending module configured to send the live broadcasting interaction information to a host terminal, where the interacting audience terminal may be any one of audience terminals in the live broadcasting room where the host terminal resides.

In accordance with an aspect of embodiments of the present disclosure, another apparatus for processing live broadcasting information is provided. The apparatus may include: a receiving module configured to receive a target video stream sent by a host terminal, the target video stream being a combination of live broadcasting interaction information and a live broadcasting video stream; and a sending module configured to send the target video stream to other audience terminal, the other audience terminal being any one of audience terminals in the live broadcasting room where the host terminal resides except an interacting audience terminal, the interacting audience terminal being the audience terminal sending the live broadcasting interaction information.

In accordance with an aspect of embodiments of the present disclosure, an interaction server is provided. The interaction server may include: a processor; a memory for storing processor-executable instructions; where the processor may be configured to: receive live broadcasting interaction information sent by an interacting audience terminal; and send the live broadcasting interaction information to a host terminal, where the interacting audience terminal may be any one of audience terminals in the live broadcasting room where the host terminal resides.

In accordance with an aspect of embodiments of the present disclosure, a live broadcasting server is provided. The live broadcasting server may include: a processor; a memory for storing processor-executable instructions; where the processor may be configured to: receive a target video stream sent by a host terminal, the target video stream being a combination of live broadcasting interaction information and a live broadcasting video stream; and send the target video stream to other audience terminal, the other audience terminal being any one of audience terminals in the live broadcasting room where the host terminal resides except an interacting audience terminal, the interacting audience terminal being the audience terminal sending the live broadcasting interaction information.

In accordance with an aspect of embodiments of the present disclosure, a system for processing live broadcasting information is provided. The system may include: a host terminal, an interaction server and a live broadcasting server; the host terminal including the apparatus for processing live broadcasting information described in any of the foregoing fourth aspect of embodiments; the interaction server including the apparatus for processing live broadcasting information described in any of the foregoing fifth aspect of embodiments; and the live broadcasting server including the apparatus for processing live broadcasting information described in the foregoing aspect of embodiments.

In accordance with an aspect of embodiments of the present disclosure, a system for processing live broadcasting information is provided. The system may include: the host terminal described in the foregoing aspect of embodiments; the interaction server described in the foregoing aspect of embodiments; and the live broadcasting server described in the foregoing aspect of embodiments.

In accordance with an aspect of embodiments of the present disclosure, A non-transitory computer-readable storage medium is provided. The non-transitory computer-readable storage medium having stored therein instructions that, when executed by a processor of a device, may cause the device to perform a method for processing live broadcasting information according to one of forgoing aspects of the present disclosure.

A non-transitory computer-readable storage medium having stored therein instructions that, when executed by a processor of a device, may cause the device to perform: receiving live broadcasting interaction information sent by an interaction server, the live broadcasting interaction information being sent to the interaction server by an interacting audience terminal; combining the live broadcasting interaction information and a live broadcasting video stream to get a target video stream; and sending the target video stream to a live broadcasting server to enable the live broadcasting server to send the target video stream to other audience terminals, where the interacting audience terminal may be any one of audience terminals in the live broadcasting room where the host terminal resides, and the other audience terminals may be audience terminals in the live broadcasting room except the interacting audience terminal.

The non-transitory computer-readable storage medium as provided above, where the live broadcasting video stream may include: live broadcasting video information and/or live broadcasting audio information; and the live broadcasting interaction information may include: screen information or gift animation information, wherein the screen information comprises at least one of: text information, system prompting information, and emoticon information.

Other embodiments of the present disclosure will be apparent to those skilled in the art from consideration of the specification and practice of the invention disclosed herein. The present application is intended to cover any variations, uses or adaptations of the present disclosure, and these variations, uses and adaptations follow the general principles of the present disclosure and include common general knowledge and conventional techniques of the art which are not disclosed herein. The specification and the embodiments are only considered as exemplary, and the true scope and spirit of the present disclosure is indicated by the following claims.

The present disclosure may include dedicated hardware implementations such as application specific integrated circuits, programmable logic arrays and other hardware devices. The hardware implementations can be constructed to implement one or more of the methods described herein. Applications that may include the apparatus and systems of various examples can broadly include a variety of electronic and computing systems. One or more examples described herein may implement functions using two or more specific interconnected hardware modules or devices with related control and data signals that can be communicated between and through the modules, or as portions of an application-specific integrated circuit. Accordingly, the computing system disclosed may encompass software, firmware, and hardware implementations. The terms “module,” “sub-module,” “unit,” or “sub-unit” may include memory (shared, dedicated, or group) that stores code or instructions that can be executed by one or more processors.

It should be appreciated that the present disclosure is not limited to the exact structures that have been described above and illustrated in the accompanying drawings, and that various modifications and changes can be made without departing from the scope thereof. It is intended that the scope of the present disclosure is only limited by the appended claims.

What is claimed is:

1. A method used at a host terminal for processing live broadcasting information, comprising:
receiving live broadcasting interaction information sent by an interaction server, the live broadcasting interaction information being sent to the interaction server by an interacting audience terminal;
combining the live broadcasting interaction information and a live broadcasting video stream to get a target video stream; and
sending the target video stream to a live broadcasting server to enable the live broadcasting server to send the target video stream to other audience terminals, wherein the interacting audience terminal is any one of audience terminals in the live broadcasting room where the host terminal resides, and the other audience terminals are audience terminals in the live broadcasting room except the interacting audience terminal.

2. The method of claim 1, wherein:
the live broadcasting video stream comprises: live broadcasting video information and/or live broadcasting audio information; and
the live broadcasting interaction information comprises: screen information or gift animation information, wherein the screen information comprises at least one of: text information, system prompting information, and emoticon information.

3. The method of claim 1, wherein the other audience terminals are a subset of the audience terminals in the live broadcasting room except the interacting audience terminal.

4. The method of claim 1, wherein each of the live broadcasting interaction information and the live broadcasting video stream occupies one image layer, such that the live broadcasting interaction information can be filtered out by anyone of the other audience terminals.

5. An apparatus used at a host terminal for processing live broadcasting information, comprising:
a processor;
a memory for storing processor-executable instructions that are executable by the processor;
wherein the processor is configured to:
receive live broadcasting interaction information sent by an interaction server, the live broadcasting interaction information being sent to the interaction server by an interacting audience terminal;
combine the live broadcasting interaction information and a live broadcast video stream to get a target video stream; and
send the target video stream to a live broadcasting server to enable the live broadcast server to send the target video stream to other audience terminals, wherein the interacting audience terminal is any one of audience terminals in the live broadcasting room where the host terminal resides, and the other audience terminals are audience terminals in the live broadcasting room except the interacting audience terminal.

6. The apparatus of claim 5, wherein:
the live broadcasting video stream comprises: live broadcasting video information and/or live broadcasting audio information; and
the live broadcasting interaction information comprises: screen information or gift animation information, wherein the screen information comprises at least one of: text information, system prompting information, and emoticon information.

7. The apparatus of claim 5, wherein the other audience terminals are a subset of the audience terminals in the live broadcasting room except the interacting audience terminal.

8. The method of claim 5, wherein each of the live broadcasting interaction information and the live broadcasting video stream occupies one image layer, such that the live broadcasting interaction information can be filtered out by anyone of the other audience terminals.

9. A system for processing live broadcasting information, comprising: a host terminal, an interaction server and a live broadcasting server;
wherein:
the host terminal comprises a host apparatus for processing live broadcasting information;
the interaction server comprises an interaction apparatus for processing the live broadcasting information, the interaction apparatus comprising a first processor; a first memory for storing first processor-executable instructions that are executable by the first processor, wherein the first processor is configured to: receive live broadcasting interaction information sent by an interacting audience terminal; and send the live broadcasting interaction information to the host terminal, wherein the interacting audience terminal is any one of audience terminals in the live broadcasting room where the host terminal resides; and
the live broadcasting server comprises a broadcasting apparatus for processing the live broadcasting information, the broadcasting apparatus comprising a second processor; a second memory for second storing processor-executable instructions that are executable by the second processor, wherein the second processor is configured to: receive a target video stream sent by the host terminal, the target video stream being a combination of the live broadcasting interaction information and a live broadcasting video stream; and send the target video stream to other audience terminal, the other audience terminal being any one of audience terminals in the live broadcasting room where the host terminal resides except an interacting audience terminal, the interacting audience terminal being the audience terminal sending the live broadcasting interaction information.

10. The system of claim 9, wherein:
the live broadcasting video stream comprises: live broadcasting video information and/or live broadcasting audio information; and
the live broadcasting interaction information comprises: screen information or gift animation information, wherein the screen information comprises at least one of: text information, system prompting information, and emoticon information.

11. The system of claim 9, wherein:
the live broadcasting interaction information comprises: screen information or gift animation information, wherein the screen information comprises at least one of: text information, system prompting information, and emoticon information.

12. The apparatus of claim 9, wherein the other audience terminal comprises a subset of the audience terminals in the live broadcasting room except the interacting audience terminal.

13. The method of claim 9, wherein each of the live broadcasting interaction information and the live broadcasting video stream occupies one image layer, such that the live broadcasting interaction information can be filtered out by the other audience terminal.
